(19) United States
(12) Patent Application Publication
(10) Pub. No.: US 2006/0170730 A1
(43) Pub. Date: Aug. 3, 2006

(54) Print head system minimizing stitch error

(76) Inventor: Robert Earl Rogers, Shawnee, KS (US)

Correspondence Address: HARNESS, DICKEY & PIERCE, P.L.C., P.O. BOX 828, BLOOMFIELD HILLS, MI, 48303, US

(21) Appl. No.: 11/301,753

(22) Filed: Dec. 13, 2005

Related U.S. Application Data
(60) Provisional application No. 60/636,431, filed on Dec. 15, 2004.

(51) Int. Cl. B41J 2/15

(52) U.S. Cl. 347/40

(57) ABSTRACT

An ink jet printing assembly and method of use for printing on a substrate where the substrate is driven in a driving direction. The ink jet printing assembly includes a first jetting assembly having a first ink orifice and a second ink orifice and a second jetting assembly separate from the first jetting assembly having a third ink orifice. The third ink orifice is positioned between the first ink orifice and the second ink orifice in a cross substrate direction. A third jetting assembly, separate from the first and second jetting assemblies, includes a fourth ink orifice. The fourth ink orifice is aligned with the first ink orifice in the cross substrate direction. The first ink orifice is fired to produce at least one ink drop at a single pixel position and the fourth ink orifice is fired to produce multiple ink drops at the single pixel position to minimize stitch error.

### CROSS-REFERENCE TO RELATED APPLICATIONS

This application claims the benefit of U.S. Provisional Application No. 60/636,431, filed on Dec. 15, 2004. The disclosure of the above application is incorporated herein by reference.

### FIELD OF THE INVENTION

The present invention relates to ink jet printing and, more particularly, relates to a print head system capable of minimizing stitch error during printing.

### BACKGROUND OF THE INVENTION

Ink jet printing is extremely popular in a wide variety of industries. Typically, ink jet printing is accomplished through the use of a print head. The print head includes a plurality of orifices each capable of depositing an ink drop upon a substrate to form a predetermined pattern, such as an image, text, and the like. The plurality of orifices contained in the print head are arranged in rows and columns and are each capable of depositing an ink drop to a defined pixel position grid (also defined as rows and columns) upon a substrate. This row and column arrangement of the orifices typically does not span the full number of rows or the full number of columns in the pixel position grid. Consequently, the print head and the substrate must be moved relative to each other to create the desired output to be printed.

As is known in the art, ink jet printing may be used in printing upon elongated substrates, such as paper rolls or sheets. The substrate is typically stopped at predetermined steps according to separate encoding systems that accurately track the longitudinal movement of the substrate. Typically, at each step, a line of ink is deposited along a row of pixels, which is often referred to as a print line.

In low resolution printing, a first section of the image is printed across the substrate to define the entire row and a length of the columns. The substrate is then advanced a step and another entire row and an additional length of the columns is deposited. This process continues until the image is completed.

In high resolution printing, the density of the ink deposits in the pixel grid is increased to provide improved resolving power. To an extent, this can be achieved by manufacturing the print head with a single lateral line of more closely spaced orifices. However, it should be understood that there are limits to the minimum spacing between adjacent orifices that can be achieved with today's manufacturing systems.

Print heads can be made as wide as the area to be printed to promote single pass printing. In this arrangement, the substrate is moved longitudinally as the print head is held stationary. An entire row of ink is deposited at a time to provide the single pass capability.

Attempts have been made to improve the resolution of existing print head designs through the use of interlace configurations. Specifically, these conventional designs employ a plurality of print heads that are arranged in multiple rows and overlapped or interlaced to stagger the print heads of each row relative to adjacent rows. In this regard, the resolution of the printing system is improved despite mechanical manufacturing limitations. However, these designs also suffer from a number of disadvantages, such as their sensitivity to yaw angle alignment of the substrate relative to the print head, the clumping of ink drops on non-absorbent substrates, and additionally the inability to nest adjacent print heads directly next to each other. These disadvantages will be discussed in further detail below.

Additionally, such arrangement of using a plurality of print heads leads to stitch error. That is, as print heads are aligned relative to each other for printing, their respective orifices may not align perfectly. Any misalignment of the print head or any variation in the orifice positions may cause a faint light or dark line to appear where multiple print heads overlap. This faint light or dark line is referred to as stitch error. Stitch error results from a tolerance buildup—namely, the orifice relative positions, the print head position relative to adjacent overlapping print heads, any misalignment of the substrate, and other factors. Although tolerances could be tightened, such would increase the manufacturing, assembly, and maintenance costs of these systems. Therefore, it is desirable to overcome or at least minimize stitch error without requiring tighter tolerances.

### SUMMARY OF THE INVENTION

According to the principles of the present invention, an ink jet printing assembly for printing on a substrate is provided having an advantageous construction and method of use. The substrate is driven in a driving direction. The ink jet printing assembly includes a first jetting assembly having a first ink orifice and a second ink orifice and a second jetting assembly separate from the first jetting assembly having a third ink orifice. The third ink orifice is positioned between the first ink orifice and the second ink orifice in a cross substrate direction. A third jetting assembly, separate from the first and second jetting assemblies, includes a fourth ink orifice. The fourth ink orifice is aligned with the first ink orifice in the cross substrate direction. The first ink orifice is fired to produce at least one ink drop at a single pixel position and the fourth ink orifice is fired to produce multiple ink drops at the single pixel position to minimize a stitch error.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view illustrating the positional relationship of the plurality of jetting assemblies of the present invention; and

FIG. 2 is an enlarged plan view illustrating the ink drop deposition pattern upon the substrate according to the method of the present invention.

### DETAILED DESCRIPTION OF THE PREFERRED EMBODIMENT

The following description of the preferred embodiment is merely exemplary in nature and is in no way intended to limit the invention, its application, or uses.

With particular reference to the figures, an ink jet printing assembly is provided having improved resolving capability, interchangeability, and reduced stitch error, in addition to many other benefits.

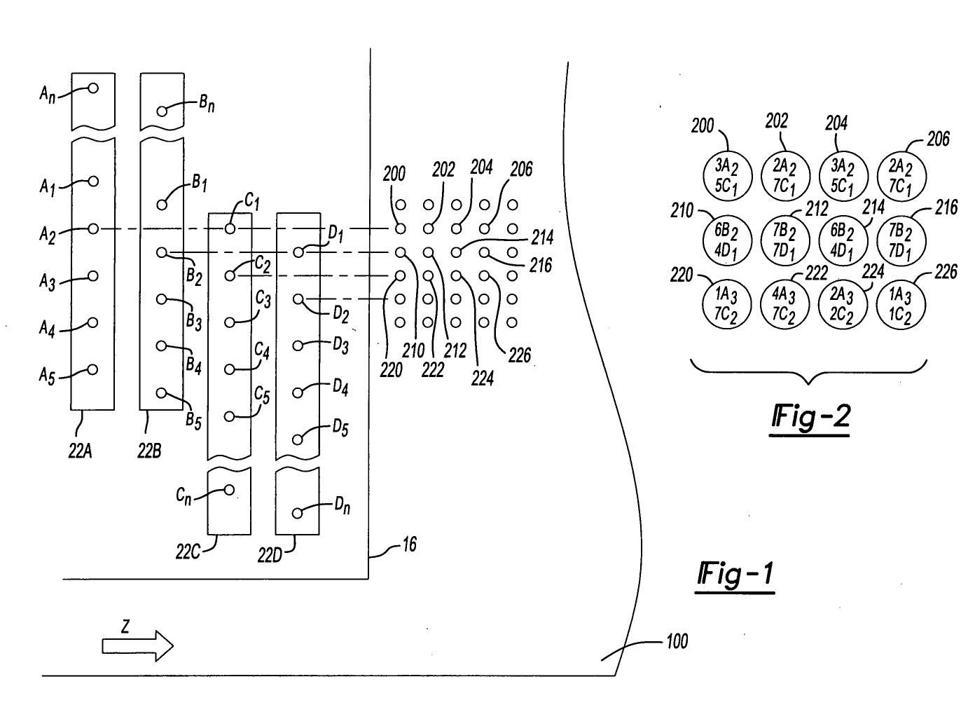

Referring to FIG. 1, a plurality of jetting assemblies or print heads 22 are illustrated, generally labeled from A-D. The plurality of jetting assemblies 22A-D are arranged in a manner to provide efficient, reliable, and simple high-resolution image production. Each of the plurality of jetting assemblies 22A-D is preferably identical in construction and ink depositing operation. Accordingly, they may be discussed collectively as jetting assembly 22.

Jetting assembly 22 is operably coupled to an ink jet printing system (not shown), such as that described generally in commonly-assigned U.S. Provisional Patent Application No. 60/568,445, which is incorporated herein by reference. The ink jet printing system generally includes an umbilical that is operably coupled to an ink supply, a control device, or any other off-board system. The umbilical is further coupled to a mounting structure 16 that is adapted to carry the weight of the various components of the ink jet printing system. An ink tube is coupled between an onboard ink reservoir and the plurality of jetting assemblies 22. A substrate 100, in this case a roll of material, is driven through a drive path Z (see FIG. 1) as it travels through the ink jet printing system in a conventional manner. Each of the plurality of jetting assemblies 22 are fixedly, yet removably, coupled to mounting structure 16.

Still referring to FIG. 1, each of the plurality of jetting assemblies 22 includes a plurality of ink orifices, generally labeled as A1, A2, A3, etc. for jetting assembly 22A and similarly for the remaining jetting assemblies 22B-D. It should be appreciated that the present invention may be used with any number of jetting assemblies having any number of ink orifices. However, for the present discussion, four jetting assemblies 22A-D having ink orifices x1-x5 will be described where x represents either A-D. It should also be recognized that the present invention is not limited to jetting assemblies having the illustrated number of overlapping orifices. Other number of overlapping orifices may be used.

The plurality of jetting assemblies 22A-D are arranged in an parallel relationship relative to each other and generally orthogonal to travel direction of substrate 100, generally indicated by the arrow Z of FIG. 1. Jetting assemblies 22A-D include orifices A1-An, B1-Bn, C1-Cn, and D1-Dn, respectively. Such orifices are operable to fire a series of ink drops. Specifically, such orifices are operable to discretely fire up to about seven ink drops repeatedly within quick succession.

In operation, ink is pumped through a filter (not shown) and enters the ink reservoir through an ink tube. The ink travels down the ink tubes to each of the plurality of jetting assemblies 22. In order to form the desired pattern, image, text, or the like, data from a controller is sent an integrated circuit board and a control signal is output to an onboard controller or chip on each of the plurality of jetting assemblies 22. This control signal commands a firing of a specific ink orifice, which produces between one and seven ink drops upon substrate 100.

An encoder is used to provide a timing signal to the integrated circuit board. In other words, the encoder is capable of monitoring the drive movement of substrate 100 to provide the necessary position data for accurately firing the selected ink orifices.

A high voltage (approx. 100V) is sent to the integrate circuit board, which is transmitted in the form of a control signal to each of the plurality of jetting assemblies 22. There may be multiple firing pulse signals sent to each jetting assembly 22. If a particular ink orifice should fire, then the data bit associated with this ink orifice is a one and the switch is closed. The data bit associated with the remaining ink orifices will remain a zero, thereby maintaining the corresponding switch (i.e. jetting assembly or ink orifice) is an opened state.

When the fire pulse is sensed by jetting assembly 22, jetting assembly 22 permits the fire pulse to pass therethrough to the associated ink orifice that is to be fired. The fire pulse causes a piezoelectric material in the ink jetting assembly 22 to expand thereby ejecting one or more ink drops from the corresponding ink orifice and depositing the ink drop upon a predetermined pixel on substrate 100.

With particular reference to FIG. 1, the process of ink deposit upon substrate 100 will now be discussed. As can be seen in FIG. 1, jetting assemblies 22A-D are arranged to provide a unique and useful deposition pattern and methodology. In the interest of brevity, only jetting assemblies 22A-D will be discussed. However, it should be appreciated that the same deposition pattern and method can be used for any number of jetting assemblies.

As described above, each jetting assembly 22 includes a plurality of ink orifices that output between one and seven ink drops in response to a fire pulse signal at a single pixel position. Jetting assemblies 22 are arranged relative to substrate travel direction Z (indicated by the arrow in FIG. 1) to form an interlace pattern. In a printing system that is perfectly aligned, ink orifice A2 is aligned with ink orifice C1 such that an ink drop dropped from ink orifice A2 could land directly on an ink drop dropped from ink orifice C1. However, in many applications tolerance buildup causes a small misalignment or stitch error between A2 and C1. Thus, if A2 and C1 are alternatively fired, a portion of the relevant pixel position will not be covered by an ink drop or may be covered by too much ink and thus produce a visible flaw, such as banding.

As seen in FIGS. 1 and 2, ink drops are preferably deposited in a manner to ensure proper coverage in the desired print area, thereby preventing or at least minimizing the occurrence of stitch error while providing improved resolution capability and resistance to misalignment problems. With particular reference to FIG. 1, the relative position of the plurality of ink orifices are illustrated between adjacent pairs of jetting assemblies, such as 22A/22B, 22C/22D, 22E/22F, etc. As can be seen, ink orifices A1-A5 are offset in a cross substrate direction (orthogonal to travel direction Z) relative to ink orifices B1-B5 in an alternating pattern—specifically, B1 is disposed between A1 and A2, B2 is disposed between A2 and A3, or in other words Bx is disposed between Ax and Ax+1. A similar relationship of ink orifices exists between jetting assemblies 22C and 22D, etc. However, jetting assembly 22C is positioned relative to jetting assembly 22A such that ink orifices A2 and C1 are aligned relative to substrate travel direction Z (as are ink orifices B2 and D1).

As can be seen in FIGS. 1 and 2, which illustrates only a portion of the ink drop deposits in the print art, ink drops are deposited such that those ink orifices that are aligned from jetting assembly to jetting assembly are fired to define an ink column 102. Specifically, according to the principles of the present invention, each pixel position, generally references as 200-206, 210-216, and 220-226, is formed using a combination of multiple ink drops deposited by the respective orifices, namely A2 and C1, B2 and D2, and A3 and C2, respectively. For example, with greater detail, pixel position 200 may be formed by firing three ink drops from orifice A2 and five ink drops from orifice C1. Neighboring pixel position 202 may be formed by firing two ink drops from orifice A2 and seven ink drops from orifice C1. Pixel position 204 may then be formed by again firing three ink drops from orifice A2 and five ink drops from orifice C1. While pixel position 206 may be formed by firing two ink drops from orifice A2 and seven ink drops from orifice C1.

Similarly, pixel position 210 may be formed by firing six ink drops from orifice B2 and four ink drops from orifice D1. Neighboring pixel position 212 may be formed by firing seven ink drops from orifice B2 and seven ink drops from orifice D1. Pixel position 214 may then be formed by again firing six ink drops from orifice B2 and four ink drops from orifice D1. While pixel position 216 may be formed by firing seven ink drops from orifice B2 and seven ink drops from orifice D1.

Finally, pixel position 220 may be formed by firing one ink drops from orifice A3 and seven ink drops from orifice C2. Neighboring pixel position 222 may be formed by firing four ink drops from orifice A3 and seven ink drops from orifice C2. Pixel position 224 may then be formed by now firing four ink drops from orifice A3 and two ink drops from orifice C2. While pixel position 226 may be formed by firing one ink drops from orifice A3 and one ink drops from orifice C2.

In this regard, as ink drops are deposited at a single pixel position from multiple orifices, the resultant ink drop may cover a large portion of the pixel position. That is, if one misaligned orifice would normally deposit an ink drop to one side of a desired pixel position and the other misaligned orifice would normally deposit an ink drop to the other side of a desired pixel position, by firing both orifices at the same pixel position a greater pixel coverage can be obtained. Additionally, by varying the respective ink drops deposited by one orifice relative to the other orifice, the resultant pixel coverage can further be improved.

It should be appreciated from the example above that for each pixel position, any combination of ink drops may be deposited from the relevant orifices ranging from zero to the maximum limit, such as seven or higher. Additionally, as seen in reference to pixel positions 220-226, the present invention is not limited to a particular repeat pattern and, thus, may be randomized to minimize error perceivable by the eye. It should also be appreciated that additional jetting assemblies may be used to provide additional orifices capable of depositing ink at a particular pixel position, thereby permitting additional ink drop combinations. Accordingly, ink column 102 is more resistant to misalignment of jetting assemblies or general tolerance buildup and provides a simple and cost effective method to minimize stitch error.

The present invention provides a number of distinct advantages over the prior art, which will now be discussed, at least in part. As is known in the art, prior art interlace designs often suffer from yaw angle misalignment of the substrate. In other words, as seen in FIG. 1, if the substrate travel direction Z is yawed to one side or the conventional print heads are misaligned, the relative alignment of ink orifices is adversely affected, which causes banding or stitch error. In contrast, as seen in FIG. 1, the present invention overcomes this disadvantage. Specifically, any yaw angle error between jetting assemblies is minimized as a result of the firing pattern capability described above.

It is typically difficult to manufacture jetting assemblies without variation in the length from the first ink orifice (i.e. A1) to the last ink orifice (i.e. A5). This variation translates into significant ink drop placement variations in traditional straight interlace designs (see FIG. 1). However, the firing pattern capability of the present invention serves to mask the errors from any such ink drop placement variations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An ink jet printing assembly for printing on a substrate, said substrate being driven in a driving direction, said substrate defining a cross substrate direction generally orthogonal to said driving direction, said ink jet printing assembly comprising:
a first jetting assembly having a first ink orifice and a second ink orifice;
a second jetting assembly separate from said first jetting assembly, said second jetting assembly having a third ink orifice, said third ink orifice being positioned between said first ink orifice and said second ink orifice in the cross substrate direction; and
a third jetting assembly separate from said first and second jetting assemblies, said third jetting assembly having a fourth ink orifice, said fourth ink orifice being aligned with said first ink orifice in the cross substrate direction, said fourth ink orifice and said first ink orifice being operable to each fire multiple ink drops at a first pixel position.

2. The ink jet printing assembly according to claim 1 wherein said first, second, and third jetting assemblies are positioned generally parallel to each other.

3. The ink jet printing assembly according to claim 1, further comprising:
a fourth jetting assembly separate from said first, second, and third jetting assemblies, said fourth jetting assembly having a fifth ink orifice, said fifth ink orifice being aligned with said third ink orifice in the cross substrate direction, said fifth ink orifice and said third ink orifice being operable to each fire multiple ink drops at a second pixel position.

4. The ink jet printing assembly according to claim 1, further comprising:
a controller for outputting a control signal to each of said first, second, and third jetting assemblies to command a firing of ink through each of said first, second, third, and fourth ink orifices.

5. An ink jet printing assembly for printing on a substrate, said substrate being driven in a driving direction, said substrate defining a cross substrate direction generally orthogonal to said driving direction, said ink jet printing assembly comprising:
a first jetting assembly having a first ink orifice and a second ink orifice;
a second jetting assembly separate from said first jetting assembly, said second jetting assembly having a third ink orifice, said third ink orifice being position between said first ink orifice and said second ink orifice in the cross substrate direction;
a third jetting assembly separate from said first and second jetting assemblies, said third jetting assembly having a fourth ink orifice, said fourth ink orifice being aligned with said first ink orifice in the cross substrate direction, at least one of said fourth ink orifice and said first ink orifice being operable to fire multiple ink drops at a first pixel position;
a fourth jetting assembly separate from said first, second, and third jetting assemblies, said fourth jetting assembly having a fifth ink orifice, said fifth ink orifice being aligned with said third ink orifice in the cross substrate direction, said fifth ink orifice and said third ink orifice being operable to each fire multiple ink drops at a second pixel position; and
a controller for outputting a control signal to each of said first, second, third, and fourth jetting assemblies to command a firing of ink through each of said first, second, third, fourth, and fifth ink orifices.

6. A method of printing on a substrate using an ink jet printing assembly, said ink jet printing assembly having a first jetting assembly having a first ink orifice and a second ink orifice, a second jetting assembly separate from said first jetting assembly, said second jetting assembly having a third ink orifice, said third ink orifice being position between said first ink orifice and said second ink orifice in the cross substrate direction, and a third jetting assembly separate from said first and second jetting assemblies, said third jetting assembly having a fourth ink orifice, said method comprising:
driving said substrate in a driving direction;
depositing at least one ink drop from said first ink orifice upon a pixel position; and
depositing at least two ink drops from said third ink orifice of said second jetting assembly upon said pixel position.
